(19) United States
(12) Patent Application Publication
(10) Pub. No.: US 2017/0076279 A1
(43) Pub. Date: Mar. 16, 2017

(54) AUTHENTICATING PURCHASES MADE WITH A HANDHELD WIRELESS DEVICE USING A VEHICLE

(71) Applicants: General Motors LLC, Detroit, MI (US); GM Global Technology Operations LLC, Detroit, MI (US)

(72) Inventors: Paul H. PEBBLES, Novi, MI (US); Nathaniel H. WILLIAMS, Berkley, MI (US); Marco T. CARNEVALE, Windsor (CA); Carl J. HERING, Farmington Hills, MI (US); Christopher L. OESTERLING, Troy, MI (US)

(21) Appl. No.: 14/850,464

(22) Filed: Sep. 10, 2015

(51) Int. Cl. G06Q 20/36; G06Q 20/32; G06Q 20/40

(52) U.S. Cl. CPC G06Q 20/3674; G06Q 20/40; G06Q 20/3278; G06Q 2220/00

(57) ABSTRACT

A system and method of authenticating purchases made with a handheld wireless device using a vehicle includes: transmitting a first security token and a second security token to a merchant via a short-range wireless connection between the handheld wireless device and the merchant; wirelessly transmitting a copy of the first security token from the handheld wireless device to a third party credit issuer; and transmitting a copy of the second security token from the handheld wireless device to the vehicle via a separate short-range wireless connection between the handheld wireless device and the vehicle.

### TECHNICAL FIELD

The present invention relates to wireless communications involving vehicles and, more particularly, to authenticating purchases made with a handheld wireless device using a vehicle.

### BACKGROUND

Rather than purchasing goods or services with paper currency, people increasingly rely on credit transactions for those purchases. A purchaser creates a credit account with a credit issuer that permits credit purchases from merchants that are ultimately paid for within a set amount of time (e.g., every month). To buy goods or services, the purchaser physically provides a credit card to a merchant that includes a magnetic stripe encoded with account information a merchant uses to debit the account belonging to the purchaser. However, people now commonly carry handheld wireless devices that can be used to wirelessly transmit payment information associated with their credit account to merchants who then debit the purchaser's account in response. Payments made using the handheld wireless device involve point-to-point communications between the device and the merchant and are often referred to as a “mobile payment system” or “contactless” payment.

Given the ability to obtain goods and services by wirelessly providing information relating to a purchaser's account, the mobile payment system used should include measures to protect against fraud. While handheld wireless devices configured to provide the mobile payment system include security features to prevent fraud in the point-to-point communications, it is possible to augment these security features in coordination with a nearby vehicle.

### SUMMARY

According to an embodiment, there is provided a method of authenticating purchases made with a handheld wireless device using a vehicle. The method includes transmitting a first security token and a second security token to a merchant via a short-range wireless connection between the handheld wireless device and the merchant; wirelessly transmitting a copy of the first security token from the handheld wireless device to a third party credit issuer; and transmitting a copy of the second security token from the handheld wireless device to the vehicle via a separate short-range wireless connection between the handheld wireless device and the vehicle.

According to another embodiment, there is provided a method of authenticating purchases made with a handheld wireless device using a vehicle. The method includes determining whether a short-range wireless connection exists between the handheld wireless device and the vehicle; receiving confirmation at a third party credit issuer or a merchant that the short-range wireless connection exists from the vehicle; wirelessly receiving at the third party credit issuer or the merchant from the handheld device a copy of a security token sent to the merchant by the handheld wireless device; and authorizing a purchase based on the copy of the security token and the received confirmation.

According to yet another embodiment, there is provided a method of authenticating purchases made with a handheld wireless device using a vehicle. The method includes detecting the handheld wireless device has initiated a payment to a merchant; determining whether a short-range wireless connection exists between the handheld wireless device and the vehicle; and authorizing the payment to the merchant when the short-range connection exists between the handheld wireless device and the vehicle.

According to yet another embodiment, there is provided a method of authenticating purchases made with a handheld wireless device using a vehicle. The method includes receiving a security token at a merchant from the handheld device; receiving confirmation at the merchant that a short-range wireless connection exists at the vehicle; wirelessly receiving a copy of the security token at the merchant from the handheld device; determining whether the security token matches the copy of the security token; and authorizing a purchase when the security token matches the copy of the security token and the short-range wireless connection exists.

According to yet another embodiment, there is a provided method of authenticating purchases made with a handheld wireless device using a vehicle. The method includes receiving a first security token from a handheld wireless device at a third party credit issuer; receiving an auxiliary authentication at the third party credit issuer from the vehicle; and determining whether to authorize a purchase based on the first security token and the auxiliary authentication.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIGS. 2-4 are block diagrams depicting different embodiments of systems and methods of authenticating purchases made with a handheld wireless device using a vehicle; and

FIG. 5 is a flow chart depicting an embodiment of a method of authenticating purchases made with a handheld wireless device using a vehicle.

### DETAILED DESCRIPTION OF THE ILLUSTRATED EMBODIMENTS

The system and method described below authenticates purchases made with a handheld wireless device using a vehicle. As purchasers use handheld wireless devices to pay for goods and services, the security of those transactions can be increased via short-range wireless communications between the handheld wireless device and the vehicle. In the past, the mobile payment systems involved communications between the handheld wireless device and the merchant. The handheld wireless device could provide the security token to a merchant selling goods or services, which would then verify the credit account information included with the security token. If the account was in good standing, the merchant could debit the purchaser's account based on the information included in the security token. However, when the merchant receives information from the handheld wireless devices directly through only one communications channel, it may be possible for an unauthorized device to fraudulent reproduce security tokens and provide those fraudulent tokens to a merchant. Thus, it would be helpful to use a vehicle to act as a trusted resource for verifying the identity of a purchaser using a handheld wireless device.

Vehicle verification of purchases made using the handheld wireless device can be carried out in different ways. For example, the handheld wireless device can establish a short-range wireless connection with the vehicle. Later, when a purchaser decides to buy goods or services, the handheld device can wirelessly transmit a first security token and a second security token to a merchant via a separate short-range wireless communications link between the handheld wireless device and the merchant. At the same or substantially the same time, a duplicate of the first security token can be sent from the handheld wireless device directly to a third party credit issuer and a duplicate of the second security token can be sent to the vehicle via the short-range wireless connection. The duplicate of the second security token can include or be accompanied by the identity of the merchant. The vehicle can verify that the handheld wireless device transmitted the duplicate of the second security token, include vehicle-identifying information, or both and then send the duplicate of the second security token to the third party credit issuer. After confirming the credit account identified by the duplicates of the first and second tokens, the third party credit issuer can transmit the duplicates of the first and second tokens to the merchant. The merchant can then compare the first and second tokens received from the handheld wireless device with the duplicate first and second tokens received from the third party credit issuer. In this system, the security tokens can be received at the merchant from a third party and at least one of the tokens may be verified to be transmitted through the vehicle. Rather than receiving information solely from the handheld wireless device, the merchant can compare information sent by the device with what it receives via the vehicle and the third party credit issuer. When the information matches, the merchant can have a heightened expectation that the purchaser is not fraudulently sending security tokens.

In another example, the existence of the short-range wireless link between the handheld wireless device and the vehicle can act as a test for permitting purchases using the handheld wireless device. A software application stored on the handheld wireless device can be dedicated to authorizing credit purchases from merchants. When the user of the handheld wireless device attempts to make a purchase, the software application can determine whether a short-range wireless link between the device and the vehicle exists. If so, the software application can allow the purchase to proceed. And if not, the software application can attempt to identify the merchant in a database of relevant services. Relevant services may include gas stations, car washes, and other similar vehicle-related commerce. In contrast, a number of goods and services may not be relevant to what would normally be consumed nearby a vehicle, such as residential construction services or airline ticket purchases. When the merchant is identified in the relevant services database, the software application can permit the transaction. Otherwise, when the software application determines that the handheld wireless device is not linked to the vehicle via short-range wireless connection and that the merchant is not in the database of relevant services, the software application can deny the transaction.

### Communications System—

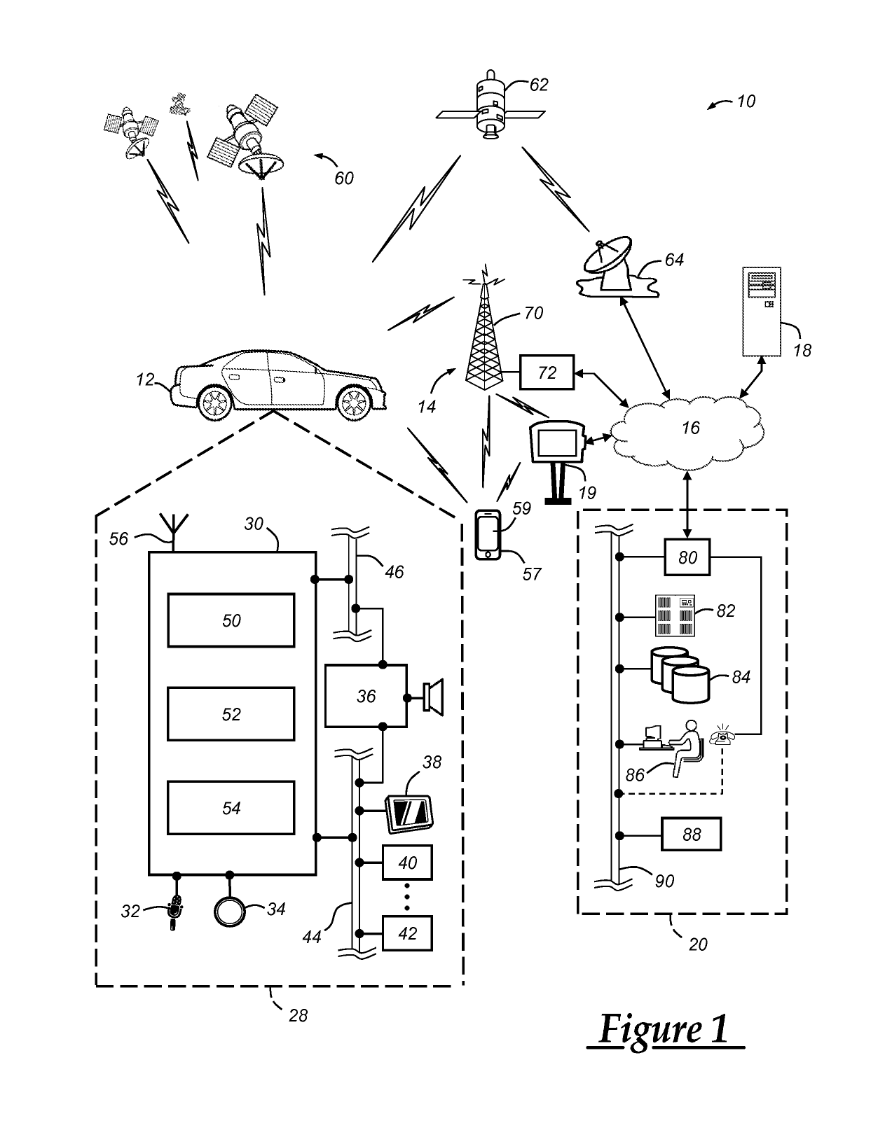

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, a merchant 19, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more short-range wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server. The wireless protocols can be used to carry out or implement wireless access points (WAPs) at the vehicle 12. As part of providing a WAP, the vehicle 12 can generate a broadcast identifier, such as a network name, that can be used by other wireless devices using short-range wireless protocols to identify the WAP and/or the vehicle 12 operating the WAP.

One of the networked devices that can communicate with the telematics unit 30 is a handheld wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface and/or a GPS module capable of receiving GPS satellite signals and generating GPS coordinates based on those signals. Examples of the smart phone 57 include the iPhone™ manufactured by Apple and the range of Galaxy™ devices manufactured by Samsung, but others are known. These and other similar devices are types of handheld wireless device for the purposes of the methods described herein. These handheld wireless devices can be configured to implement mobile payment systems, such as Apple Pay, or other similar mechanisms. The mobile payment systems can involve short-range wireless communication protocols involving near-field communications (NFC) or short-message service (SMS) messages that the handheld wireless devices are configured to use. While the smart phone 57 is described in conjunction with the methods below, it should be appreciated that other similar and/or simpler handheld wireless device can be successfully substituted for the smart phone 57 to carry out the methods/systems described herein. For instance, handheld wireless devices such as the iPad™ or iPod Touch™ can also use the short-range wireless protocols to communicate despite not having the capability to communicate via cellular protocols.

Mobile payment systems use wireless communication mechanisms to transmit information associated with a purchaser to a merchant that uses the information to debit the purchaser's account. As noted above, a variety of different mechanisms can be used to implement the mobile payment systems, such SMS messages and NFC. SMS messages transmitted from the vehicle telematics unit 30 or the smart phone 57 can include security tokens that include account information of the purchaser using the smart phone 57. The security tokens may be referred to as software tokens that can be small data files stored in a memory device at the smart phone 57. The smart phone 57 can duplicate the security tokens and wirelessly transmit them to a recipient that can use them to identify the sender (in this implementation, a purchaser). The security tokens can be implemented using a cryptographic key that converts data into security tokens using a cryptographic hash function. In some implementations, the security tokens can be a message authentication code (MAC), but other ways of implementing security tokens will be apparent to those skilled in the art. The security tokens can be installed or otherwise provided to the vehicle as is known to those skilled in the art.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000; 1xEV-DO), GSM/GPRS, HSPA+, or 4G LTE. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Merchant 19 sells at least some goods or services using mobile payment systems that charge credit accounts much like occurs when a purchaser physically provides a credit card. Broadly speaking, the smart phone 57 can be brought within a range of the merchant 19 within which a short-range wireless link may be established. In some embodiments, the short-range wireless link uses NFC, while in other embodiments, IEEE 802.11 protocols or Bluetooth Low Energy (BLE) could be used. The merchant 19 can include electronic hardware, such as a microprocessor, a memory device, a transceiver, and an antenna, that collectively facilitate wireless communications between the merchant 19 and the smart phone 57 as well as communications (wireless and wired) with the vehicle 12 and the servers of the third party credit issuer at computer 18. The merchant 19 can communicate via the short-range wireless communication connection, the wireless carrier system 14, and/or the land network 16. Merchant 19 can include attendant-less transactions like those carried out at a fuel pump or car wash as well as those overseen by humans, like at a coffee shop or drug store.

The computer 18 can host the servers of the third party credit issuer that authorizes credit transactions initiated by purchasers and merchants. The third party credit issuer is a term that encompasses an acquiring bank, a card-issuing bank, or both. The acquiring bank can be used by the merchant 19 to receive funds on its behalf while the card-issuing bank can provide funds on the purchaser's behalf and debit those funds to a credit account associated with the purchaser.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

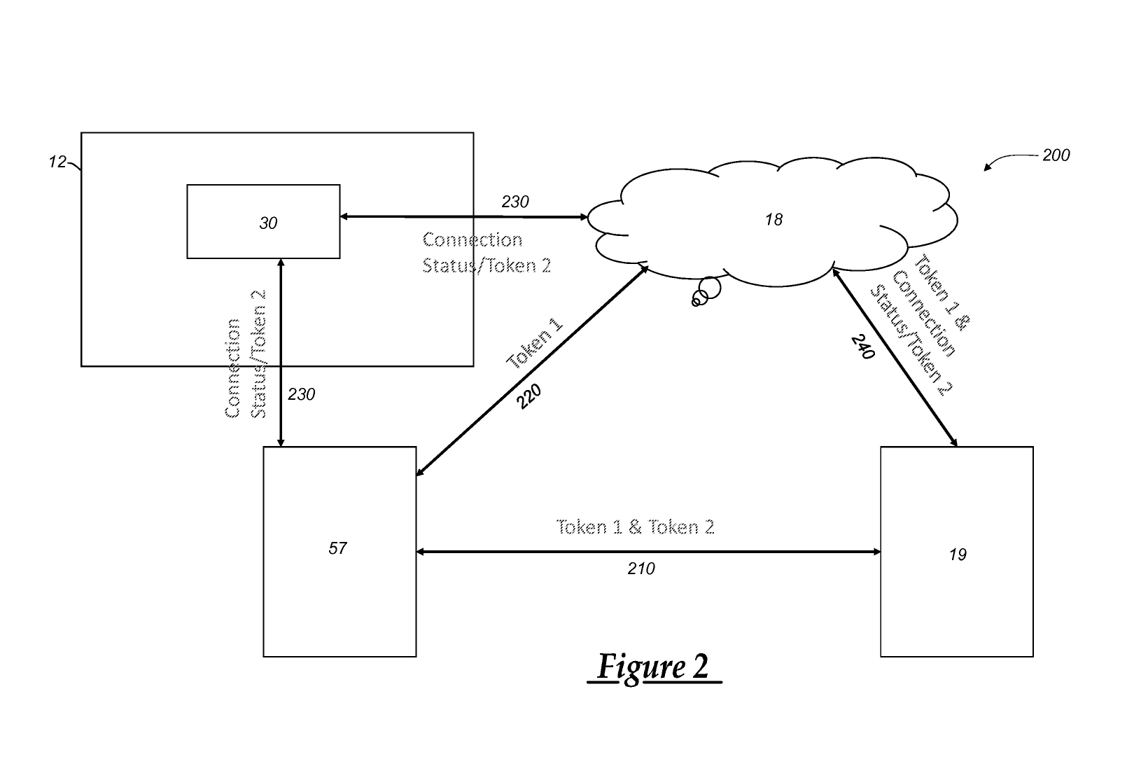

Turning to FIG. 2, a block diagram is shown of an embodiment of a system 200 and method of authenticating purchases made with the smart phone 57 using the vehicle 12. The method begins at step 210 by wirelessly transmitting a first security token and a second security token to the merchant 19 via a short-range wireless connection between the smart phone 57 and the merchant 19. When a purchaser initiates payment to the merchant 19, the smart phone 57 can establish a short-range communication connection that may be used to transmit the first and second security tokens. The smart phone 57 can access its memory device(s) and at the direction of a microprocessor, obtain the first and second security tokens and then provide those tokens to the merchant 19 via the short-range wireless connection. The method proceeds to step 220.

At step 220, a copy of the first security token is wirelessly transmitted from the smart phone 57 to the third party credit issuer at the computer 18. As part of accessing the first and second security tokens at the smart phone 57, copies of the first security token and the second security token can be made and wirelessly transmitted to the third party credit issuer at the computer 18 and the vehicle 12, respectively. In addition to transmitting the first and second security tokens to the merchant 19, the smart phone 57 transmits a copy of the first security token to the third-party credit issuer at the computer 18. The copy of the first security token can be sent to the computer 18 as packetized data using one of many different ways, such as via a cellular call or an SMS message via the wireless carrier system 14. The method proceeds to step 230.

At step 230, a copy of the second security token is wirelessly transmitted from the smart phone 57 to the vehicle 12 via a separate short-range wireless connection between the smart phone 57 and the vehicle 12. The vehicle 12 can receive the copy of the second security token and authenticate it in one or more ways. The vehicle telematics unit 30 can append a data message onto the copy of the second security token that confirms to a receiver that the copy of the second security token was received over the short-range wireless connection between the vehicle 12 and the smart phone 57. Or the vehicle telematics unit 30 can append a data message onto the copy of the second security token that includes the identity of the vehicle 12, the identity of the purchaser, or both. After appending the data message onto the copy of the second security token, the vehicle telematics unit 30 can wirelessly transmit the token to the third party credit issuer at the computer 18 via the wireless carrier system 14. The third party credit issuer can verify the credit account associated with the copies of the first and second security tokens and/or verify the identity of the purchaser based on the vehicle identity. If the credit account is valid, the third party credit issuer can then wirelessly transmit the copies of the first and second security tokens to the merchant 19. The method proceeds to step 240.

At step 240, the copies of the first security token and the second security token are received at the merchant 19 and compared with the first security token and the second security token directly received at the merchant 19 from the smart phone 57 during step 210. Payment is authorized to the merchant 19 when the copies of the first security token and the second security token match the first security token and second security token received during step 210. Otherwise, the merchant 19 can determine that the first and second security tokens and the copies of those tokens do not match and then may reject the purchaser's requested transaction. The method then ends.

Other embodiment of the system and method shown in FIG. 2 are possible. For example, rather than using first and second security tokens, a single security token can be used by the smart phone 57 along with a connection status that indicates whether or not the smart phone 57 is wirelessly linked with the vehicle telematics unit 30 via a short-range wireless connection. The second security token, its copy, and the connection status of the short-range wireless connection between the vehicle 12 and the smart phone 57 can each be viewed as a type of auxiliary authentication used in addition to the first security token as an additional fraud-protection measure. After sending the first security token to the merchant 19 and a copy of the first security token to the third party credit issuer at the computer 18, the smart phone 57, using a software application, can determine that the short-range wireless connection between it and the vehicle telematics unit 30 exists and create a data message indicating this status.

The data message indicating the connection status can then be communicated to the vehicle telematics unit 30 over the short-range wireless connection. The connection status can be identified by the software application resident on the smart phone 57. An owner of the vehicle 12 or someone authorized to used the vehicle 12 can identify the vehicle 12 when initializing or configuring the settings of the software application. This initialization can prevent an unauthorized 3^{rd} party from accessing the vehicle 12 via Bluetooth. In another embodiment, the owner or authorized user could select an “allow” function presented on the display inside the vehicle 12 and on the phone thereby verifying that the smart phone 57 paired to the vehicle 12 is carried out by someone who has access to the vehicle 12. That prevents an unauthorized 3^{rd} party from paring to a vehicle without permission. The vehicle telematics unit 30 can wirelessly transmit the data message to the third-party credit issuer. Along with the connection status, the vehicle 12 and the smart phone 57 can each determine a GPS location and determine that they are within a predetermined range of each other. In other embodiments, the vehicle telematics unit 30 can be programmed to determine this connection status and send it to the third party credit issuer rather than it being determined by the smart phone 57.

After verifying the credit account associated with the purchaser, the third-party credit issuer can transmit the copy of the first security token and the data message or other authorization to the merchant 19. The merchant 19 can compare the first security token received from the smart phone 57 with the copy of the first security token received from the third-party credit issuer. When the tokens match and the data message indicates that the smart phone 57 is currently connected to the vehicle telematics unit 30 via a short-range wireless connection, the transaction initiated by the purchaser is allowed. Otherwise, if either the security tokens do not match or the smart phone 57 is not connected to the vehicle telematics unit 30 via the short-range wireless connection, then the transaction can be denied. In some implementations, the third party credit issuer can read the data message indicating the connection status and when the smart phone 57 is connected to the vehicle telematics unit 30, transmit the first security token to the merchant 19. When the data message indicates that the smart phone 57 is not connected to the vehicle telematics unit 30 via the short-range wireless connection, the third party credit issuer can refrain from sending the first security token to the merchant 19 thereby ending the purchase.

In some implementations, the methods described herein may involve a purchaser who uses a credit account associated with someone or some entity other than the purchaser. For example, some fleet owners may maintain credit accounts associated with the vehicle 12. The purchaser can purchase goods or services using the fleet owner's credit account. For example, some car rental services include the cost of fuel as part of renting a vehicle. However, the car rental service may incentivize purchaser to refuel the vehicle in return for additional use of the vehicle or other discounts. In this example, the vehicle 12 could be associated with a credit account that is at least partially maintained or recorded at the vehicle 12 that the purchaser can access using the smart phone 57 as part of the methods disclosed herein.

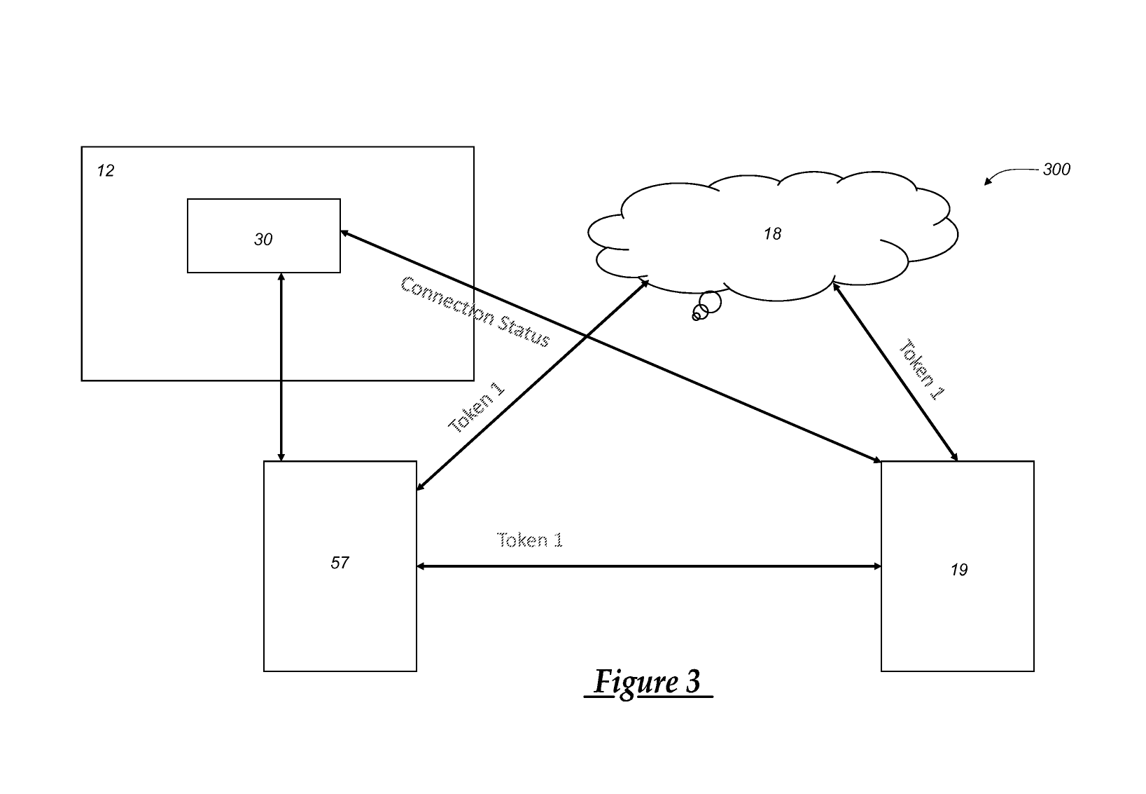

Turning to FIG. 3, a block diagram is shown of another embodiment of a system 300 and method of authenticating purchases made with the smart phone 57 using the vehicle 12. The method begins by transmitting a first security token from the smart phone 57 to the merchant 19 and transmitting a copy of the first security token from the smart phone 57 to the third party credit issuer at computer 18. These security tokens can be transmitted as is described above. The smart phone 57 can detect whether a short-range wireless connection exists between the smart phone 57 and the vehicle telematics unit 30. However, in some implementations, the vehicle telematics unit 30 can detect that the short-range wireless connection exists. A data message indicating the status of the short-range wireless connection can be generated by either the smart phone 57 or the vehicle telematics unit 30. Another short-range wireless connection can be established between the vehicle telematics unit 30 and the merchant 19. The vehicle telematics unit 30 can then wirelessly transmit the data message to the merchant 19. Once the third-party credit issuer at the computer 18 authenticates the credit account associated with the copy of the first security token, the copy of the first security token can be transmitted to the merchant 19. The merchant 19 can receive the copy of the first security token from the third-party credit issuer and compare it to the first security token received from the smart phone 57. When the security tokens match and the data message indicates that the smart phone 57 is currently connected to the vehicle telematics unit 30 via a short-range wireless connection, the transaction initiated by the purchaser can be allowed. Otherwise, if either the security tokens do not match or the smart phone 57 is not connected to the vehicle telematics unit 30 via the short-range wireless connection, then the transaction can be denied.

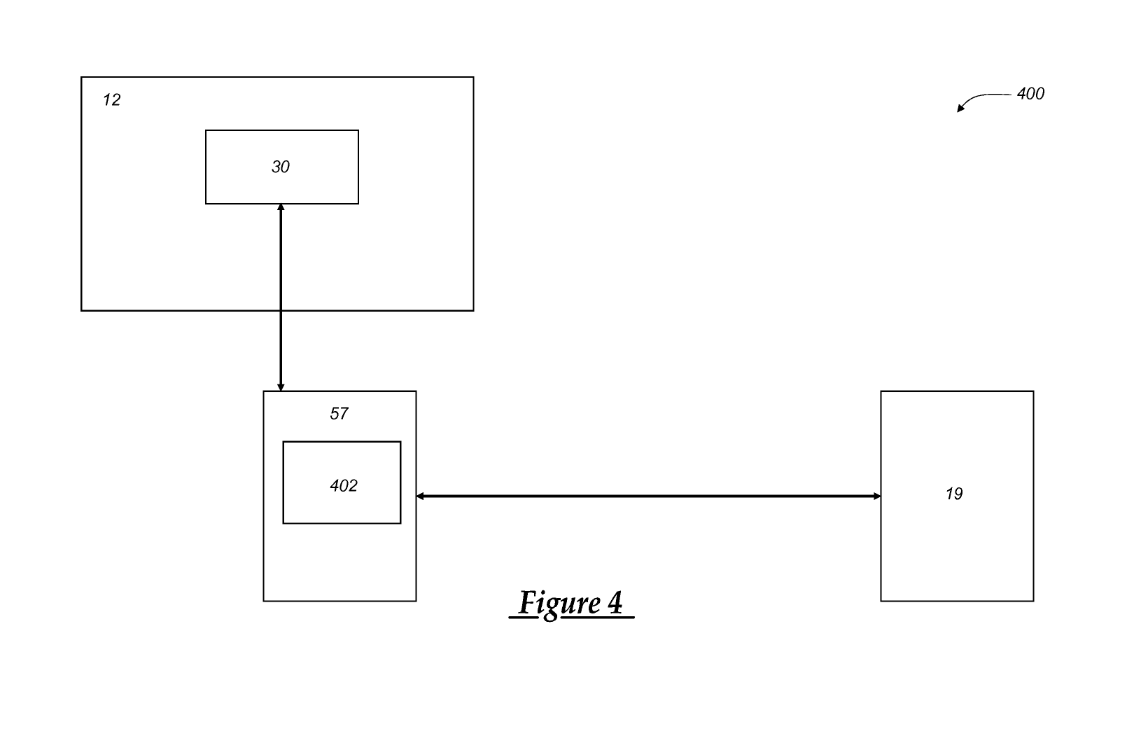

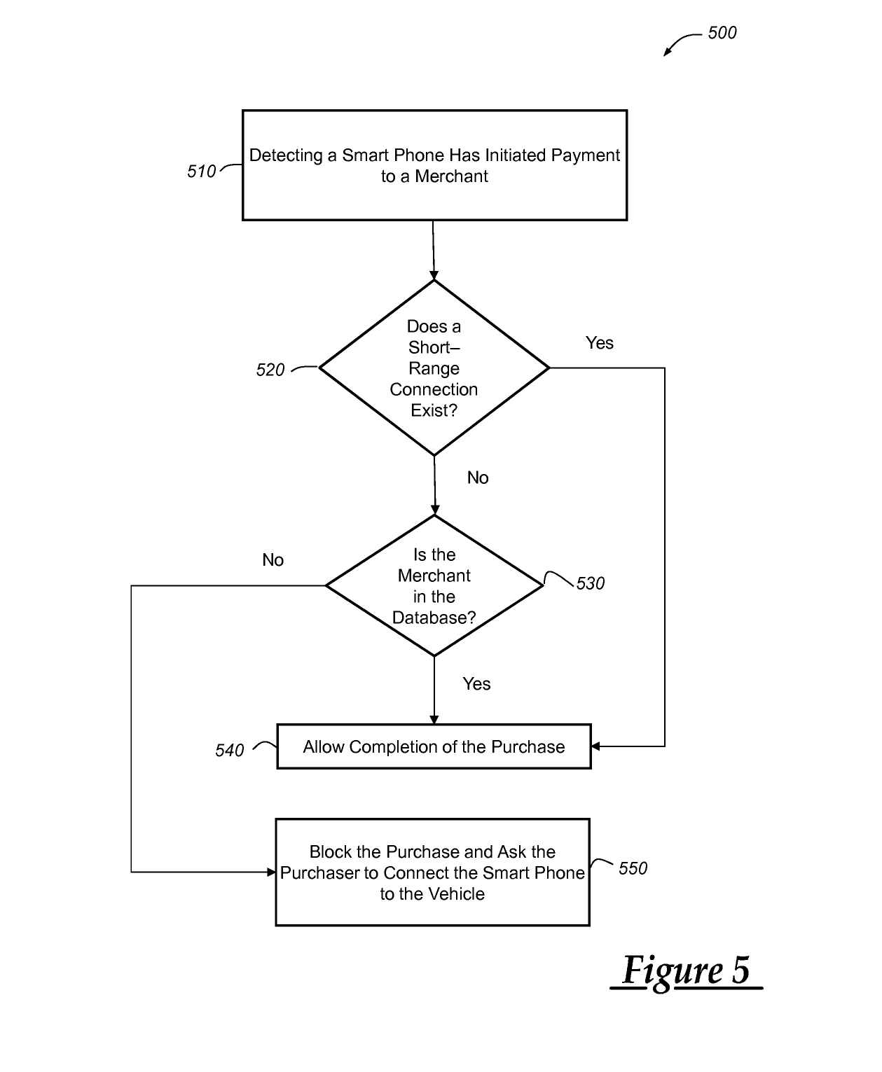

FIGS. 4-5 depict an embodiment of a system 400 and method 500 of authenticating purchases made with the smart phone 57 using the vehicle 12. The method 500 begins at step 510 by detecting the smart phone 57 has initiated a payment to the merchant 19. The purchaser can use the smart phone display 59 to select the mobile payment system and control payment to the merchant 19. A software application 402 stored locally at the smart phone 57 may detect the purchaser's initiation of payment and direct the smart phone 57 establish a short-range wireless connection with the vehicle telematics unit 30. The method 500 proceeds to step 520.

At step 520, the smart phone 57 can determine whether a short-range wireless connection exists with the vehicle telematics unit 30. If so, the method 500 proceeds to step 540 and the smart phone 57 can permit the purchase initiated by the purchaser based on the existence of the short-range wireless connection with the vehicle telematics unit 30. However, if the smart phone 57 does not detect the short-range wireless connection, the method 500 proceeds to step 530 and the smart phone 57 can then determine whether the merchant 19 is identified in a database of relevant services.

The database of relevant services can be a searchable list or data structure of merchants or merchant types that may be logically provide goods and services while the purchaser is using the vehicle 12. For example, relevant services may involve gas stations, convenience stores, vehicle service shops, or coffee shops to name a few. By providing a database of relevant services, it is possible to exclude purchases from merchants that may not logically be visited while using the vehicle 12, such as a vending machine in a public transportation subway. The database can be stored at the smart phone 57 and may be searchable at the direction of the software application 402 by name of the merchant 19. However, it is also possible to locate the database away from the smart phone 57 at a central facility that is accessible via wireless communication techniques. In some implementations, the merchant 19 can be associated with a relevant services code or identifier that indicates a class of goods and/or services provided by the merchant 19. The smart phone 57 can then receive the identifier from the merchant 19 via a short-range wireless link or through the wireless carrier system 14 shown in FIG. 1. The smart phone 57 can then search for the identifier in the database and determine if the merchant 19 sells an approved class of goods/services. If the merchant 19 is in the database or sells goods/services in an approved class, the smart phone 57 can proceed to step 540 and allow the purchase. Otherwise, the method 500 progresses to step 550.

At step 550, the smart phone 57 determines that a short-range wireless link to the vehicle 12 does not exist and that the merchant 19 is not identifiable in the database of relevant services. The smart phone 57 can present a message to a user instructing them to pair the smart phone 57 with the vehicle 12 in order to complete the purchase. The method 500 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of authenticating purchases made with a handheld wireless device using a vehicle, comprising the steps of:
(a) transmitting a first security token and a second security token to a merchant via a short-range wireless connection between the handheld wireless device and the merchant;
(b) wirelessly transmitting a copy of the first security token from the handheld wireless device to a third party credit issuer; and
(c) transmitting a copy of the second security token from the handheld wireless device to the vehicle via a separate short-range wireless connection between the handheld wireless device and the vehicle.

2. The method of claim 1, further comprising the steps of:
(d) receiving the copies of the first security token and the second security token at the merchant;
(e) comparing the copies of the first security token and the second security token with the first security token and the second security token transmitted to the merchant during step (a); and
(f) authorizing payment to the merchant when the copies of the first security token and the second security token match the first security token and second security token transmitted during step (a).

3. The method of claim 2, further comprising the step of wirelessly transmitting the copies of the first security token and the second security token from the third party credit issuer to the merchant.

4. The method of claim 1, further comprising the step of wirelessly transmitting the copy of the second security token from the vehicle to the third party credit issuer.

5. The method of claim 1, further comprising the step of verifying a credit account associated with a purchaser at the third party credit issuer.

6. The method of claim 2, further comprising the steps of including a vehicle identifier with the copy of the second security token at the vehicle and transmitting the vehicle identifier and the copy of the second security token to the third party credit issuer.

7. The method of claim 1, wherein the first security token and the second security token are stored at the handheld wireless device.

8. A method of authenticating purchases made with a handheld wireless device using a vehicle, comprising the steps of:
(a) wirelessly receiving at a third party credit issuer or a merchant a copy of a security token sent to the merchant by the handheld wireless device;
(b) receiving confirmation at a third party credit issuer or a merchant that a short-range wireless connection exists between the handheld device and the vehicle; and
(c) authorizing a purchase based on the copy of the security token and the received confirmation.

9. The method of claim 8, further comprising the step of verifying a credit account associated with a purchaser at the third party credit issuer based on the copy of the security token.

10. The method of claim 8, further comprising the step of receiving a vehicle identifier with the confirmation that the short-range wireless connection exists and determining based on the vehicle identifier that the token is associated with the vehicle.

11. The method of claim 8, further comprising the steps of wirelessly receiving a security token at the merchant from the handheld device and comparing the security token received at the merchant with the copy of the security token.

12. A method of authenticating purchases made with a handheld wireless device using a vehicle, comprising the steps of:
(a) detecting the handheld wireless device has initiated a payment to a merchant;
(b) determining whether a short-range wireless connection exists between the handheld wireless device and the vehicle; and
(c) authorizing the payment to the merchant when the short-range connection exists between the handheld wireless device and the vehicle.

13. The method of claim 12, further comprising the step of:
(d) determining whether the merchant is identified in a database of relevant services when the short-range wireless connection between the handheld wireless device does not exist.

14. The method of claim 13, wherein if the merchant is identified in the database, authorizing the payment to the merchant despite the lack of short-range wireless connection between the handheld wireless device and the vehicle.

15. The method of claim 13, wherein if the merchant is not identified in the database and a short-range wireless connection between the handheld device and the vehicle does not exist, preventing the payment to the merchant.

16. The method of claim 13, wherein the database is stored at the handheld wireless device.

17. The method of claim 13, wherein the database identifies merchants by name.

18. The method of claim 13, wherein the database identifies merchants by one more classes of goods or services.

19. The method of claim 12, wherein the handheld wireless device is a smart phone.

20. The method of claim 12, wherein step (b) is carried out at the direction of a software application stored at the handheld wireless device.
